(19) United States
(12) Patent Application Publication
(10) Pub. No.: US 2013/0124226 A1
(43) Pub. Date: May 16, 2013

(54) Method and Apparatus for Coordinating Healthcare of Patients

(71) Applicant: Murthy Gedala, Shavano Park, TX (US)

(72) Inventor: Murthy Gedala, Shavano Park, TX (US)

(21) Appl. No.: 13/674,015

(22) Filed: Nov. 10, 2012

Related U.S. Application Data
(60) Provisional application No. 61/557,980, filed on Nov. 10, 2011.

(51) Int. Cl. G06Q 50/24

(52) U.S. Cl. CPC G06Q 50/24
USPC 705/3

(57) ABSTRACT

Methods and systems for coordinating care of patients are disclosed, including enrolling a patient onto a communication facilitator application; storing an electronic record pertaining to the patient; establishing a patient healthcare team group for sending and receiving messages; storing a list of one or more members of the patient healthcare team group in the electronic record; receiving from the patient or the one or more members of the patient healthcare team group a message directed to one or more members of the patient healthcare team group; checking if the message is a permitted communication between the patient or the one or more members of the patient healthcare team group and the one or more members of the patient healthcare team group; and if the message is a permitted communication, directing the message to the one or more members of the patient healthcare team group. Other embodiments are described and claimed.

### I. CROSS REFERENCE TO RELATED APPLICATIONS

This application claims the benefit of the filing date of U.S. Provisional Patent Application Ser. No. 61/557,980, filed on Nov. 10, 2011, entitled “Method and Apparatus for coordinating post-discharge care of hospitalized patients,” the entire disclosure of which is hereby incorporated by reference into the present disclosure.

### II. BACKGROUND

The invention relates generally to the field of communication for the coordination of patient care. More particularly, the invention helps hospitals, other health care facilities, and healthcare providers provide a safety net to their patients in order to reduce patient re-admittance to healthcare facilities and to improve patient satisfaction and health outcomes.

### III. SUMMARY

In one respect, disclosed is an apparatus for coordinating care of patients, the apparatus comprising: one or more processors; system memory coupled to the one or more processors; one or more non-transitory memory units coupled to the one or more processors; and communication facilitator code stored on the one or more non-transitory memory units that when executed by the one or more processors are configured to perform a method, comprising: enrolling a patient onto a communication facilitator; storing an electronic record pertaining to the patient on the one or more non-transitory memory units; establishing a patient healthcare team group for sending and receiving group messages within and/or between the patient and the patient healthcare team group, the patient healthcare team group being associated with the patient; storing a list of one or more members of the patient healthcare team group in the electronic record; receiving from the patient or the one or more members of the patient healthcare team group a message directed to the patient or the one or more members of the patient healthcare team group; checking if the message is a permitted communication between the patient or the one or more members of the patient healthcare team group and the patient or the one or more members of the patient healthcare team group; and if the message is a permitted communication, directing the message to the patient or the one or more members of the patient healthcare team group.

In another respect, disclosed is a method for coordinating care of patients, the method comprising: a computer system, which includes one or more processors, system memory coupled to the one or more processors, one or more non-transitory memory units coupled to the one or more processors, and communication facilitator code stored on the one or more non-transitory memory units; enrolling a patient onto a communication facilitator; storing an electronic record pertaining to the patient on the one or more non-transitory memory units; establishing a patient healthcare team group for sending and receiving group messages within and/or between the patient and the patient healthcare team group, the patient healthcare team group being associated with the patient; storing a list of one or more members of the patient healthcare team group in the electronic record; receiving from the patient or the one or more members of the patient healthcare team group a message directed to the patient or the one or more members of the patient healthcare team group; checking if the message is a permitted communication between the patient or the one or more members of the patient healthcare team group and the patient or the one or more members of the patient healthcare team group; and if the message is a permitted communication, directing the message to the patient or the one or more members of the patient healthcare team group.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIG. 1 is a block diagram illustrating a communication facilitator apparatus for coordinating care of patients, in accordance with some embodiments.

FIG. 2 is a smartphone screenshot of the initial screen of the communication facilitator application, in accordance with some embodiments.

FIG. 3 is a smartphone screenshot of the login screen of the communication facilitator application, in accordance with some embodiments.

FIG. 4 is a smartphone screenshot of the patient search screen of the communication facilitator application, in accordance with some embodiments.

FIG. 5 is a smartphone screenshot of list of patients that the healthcare team member is a part of, in accordance with some embodiments.

FIG. 6 is a smartphone screenshot of the text message input screen of the communication facilitator application, in accordance with some embodiments.

FIG. 7 is a smartphone screenshot of the healthcare team list for a particular patient, in accordance with some embodiments.

FIG. 8 is a smartphone screenshot of a text message exchange between a hospital nurse and a doctor of the patient, in accordance with some embodiments.

FIG. 9 is a smartphone screenshot of a text message exchange between a hospital nurse and a case manager of the patient, in accordance with some embodiments.

FIG. 10 is a smartphone screenshot of a text message exchange between a hospital nurse and a home health nurse of the patient, in accordance with some embodiments.

FIG. 11 is a smartphone screenshot of a text message exchange between a hospital nurse and a pharmacist of the patient, in accordance with some embodiments.

FIG. 12 is a smartphone screenshot of a text message exchange between a hospital nurse and a cardiologist of the patient, in accordance with some embodiments.

FIG. 13 is a smartphone screenshot illustrating the option of forwarding a patient's message to one or more healthcare team members, in accordance with some embodiments.

FIG. 14 is a smartphone screenshot of a patient's hospital admission history, in accordance with some embodiments.

FIG. 15 is a smartphone screenshot of a text messaging exchange between a patient and their doctor allowing the patient to link to a feedback form, in accordance with some embodiments.

FIG. 16 is a block diagram illustrating a method for coordinating post-discharge care of hospitalized patients, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

There is pressure to shorten hospitalization of sick patients to the point that when the patient's care no longer needs in-patient intervention they are transitioned to different health care facilities for post-acute care such as a Skilled Nursing Facility, a Rehabilitation Hospital, a Long Term Acute Care Facility, or a home with Home Health Care. Sometimes, patients get discharged from hospitals when they don't yet feel ready and as a result, the patients may have a high level of anxiety in connection with being discharged. Compounding this situation, patients sometimes do not necessarily understand all the instructions relating to their care. As a result, their post discharge can have sub-optimal outcomes. At times, patients want to get in touch with a member of their healthcare team, such as a nurse, a case manager, a pharmacist, or discharging doctor to clarify instructions or to report a new problem. Unfortunately, it is not easy for a patient to contact a member of their healthcare team, especially when there is an “acute need”.

Another problem resulting from the limited communication between a patient and the members of their healthcare team, especially in the out-patient setting, arises when patients are being treated by different physicians. The patient may actually be taking more medicines than they need to, due to a lack of co-ordination between the treating physicians. Sometimes, the number of pills being taken by the patient can be reduced if instead combination pills were prescribed and in the case of a financially strapped patient, equally effective, less expensive, generic medicines could be prescribed.

President Obama's 2010 budget singled out hospital readmissions as the largest source of waste in the American healthcare system. In 2004, nearly 12 million Medicare patients were discharged from a hospital in the U.S. Unfortunately, nearly one in five of the Medicare patients were readmitted within a month of discharge. In 2004, the readmitted Medicare patients cost an estimated $17.4 billion dollars. Of those Medicare patients that were readmitted, more than three quarters could have been prevented. Fifty percent of Medicare patients readmitted to the hospital had not had any out-patient follow-up visits with a clinician after their first hospitalization. A portion of these readmissions could have been prevented by better communication between the patient and the patient's healthcare team. Not surprisingly, the Center for Medicare and Medicaid Services has indicated an interest in making re-hospitalization rates a measure for value-based payment. Such a proposal would radically change the hospital's accountability for patient outcomes after discharge. Additionally, Medicare Administrative Contractors have recently begun informing hospitals that any readmission that occurs within 30 days of an acute stay discharge is subject to review and referral to the quality improvement organization with a possible payment denial resulting for the second admission, the initial admission, or both.

The Patient Protection and Affordable Care Act under the “Hospital Readmissions Reduction Program” is projected to reduce hospital reimbursement for Medicare patients by $1.2 billion by 2014 and $8.2 billion by 2019. The reduced hospital reimbursements are to be calculated by taking the product of the base operating diagnosis-related group payment amount for the discharge, times an adjustment factor for the particular hospital for the fiscal year. The adjustment factor is going to be capped at 1% for 2012, at 2% for 2013, at 3% for 2014, and at 5% for 2015 and beyond. This reduction in reimbursement is not just going to be for readmissions within 30 days, but also for all diagnosis-related group payments for “outlier” hospitals that did not originally treat the patient. The federal government's pressure to lower patient readmissions is not the only force acting on hospitals. Hospitals are also very sensitive to patient satisfaction scores afforded to them by discharged patients, such as Press Ganey scores. These patient satisfaction scores have an influence on the public perception of the hospital. Starting in 2013, the federal government is even going to base 30% of hospital Medicare reimbursement on patient experience. Lowering patient readmissions would go a long way in improving a hospital's public perception and patient's experience.

Patient readmissions can potentially be lowered by improving communication between the healthcare provider and the patient. By improving communications, patients can be guided post-discharge with the ability to intervene at the slightest deviation from the normal course of recovery, thus improving health outcomes. Unfortunately, nurses and doctors do not like to give out their cell phone numbers to patients for fear of patients abusing this access. As a result, patients typically have to call the doctor's office or answering service and have to leave a message for the doctor or nurse to call the patient back. In the case for a prior hospitalization, the patient has to call the hospital to try and have the nurse, case manager, or pharmacist tracked down before the patient can voice their concerns or to get advice regarding their medical treatment. Timely and efficient communication is imperative for both effective patient care as well as satisfaction. For example, if a patient does return to a hospital emergency room, the E.R. physician is not typically in the best position to evaluate the patient in order to make an admission decision. The discharging physician who is quite familiar with the patient's recent hospitalization would be in a better position for determining whether the patient needs to be readmitted into the hospital. By establishing a communication link between the discharged patient and the discharging physician, measures can be taken that could potentially avert an unplanned readmission. For one, the patient could be briefly brought back to the medical floor for an evaluation to ensure if a readmission is really necessary. Doing so would not only potentially save the patient a lot of hassle, but would also have the added benefit of decongesting the E.R.

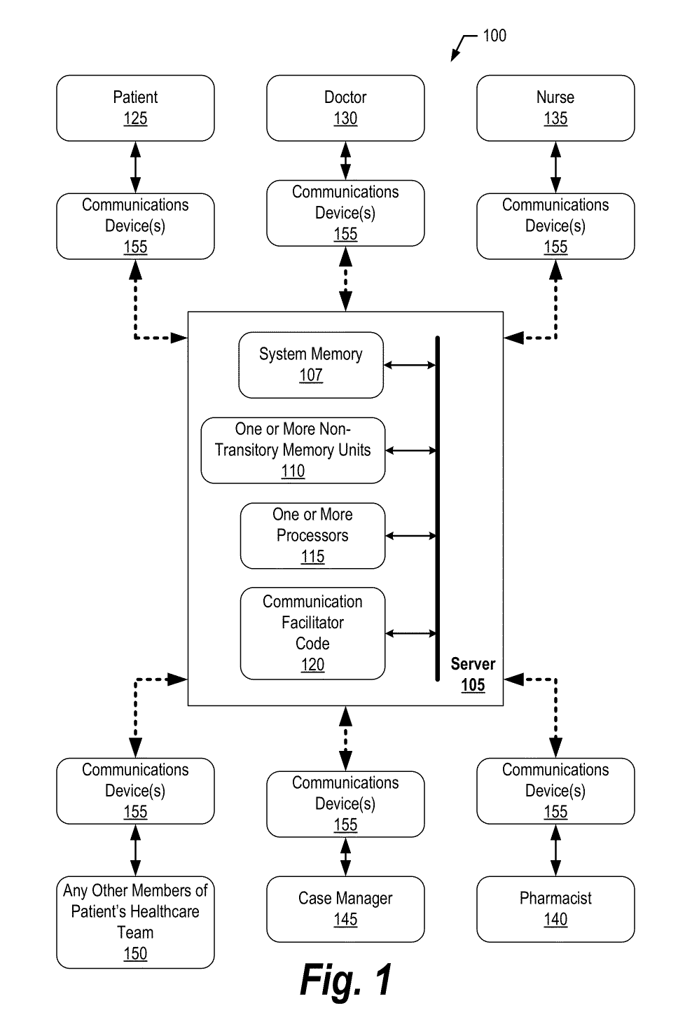

FIG. 1 is a block diagram illustrating a communication facilitator apparatus for coordinating care of patients, in accordance with some embodiments.

In some embodiments, a communication facilitator application ecosystem 100 for the coordination of post discharge care of a hospitalized patient comprises a computer or server 105, a patient 125 with access to communications device(s) 155, and members of the patient's healthcare team with access to communications device(s) 155. The server 105 comprises system memory 107, one or more non-transitory memory units 110, one or more processors 115, and a communication facilitator code or program 120. In this embodiment, a patient 125, a doctor 130, a nurse 135, a pharmacist 140, a case manager 145, and any other member of the patient's healthcare team 150 are able to communicate via the communication facilitator application ecosystem 100. Communication between the server 105 and the communications devices 155 may occur over any suitable wireless and/or wired network such as, for example, the Internet, an intranet, a wireless area network, a local area network, a cellular network, and/or the like. The patient 125 and members of their healthcare team 130, 135, 140, 145, 150 are able to communicate via the communication facilitator application ecosystem 100 by using a communications device 155 such as a smartphone or other computing device. The smartphone could have the communication facilitator code or program “app” installed in order to communicate via the communication facilitator application ecosystem 100, but could also access the web interface of the communication facilitator application ecosystem 100. The computing device such as, a desktop computer, laptop computer, or tablet, could access the web interface of the communication facilitator application ecosystem 100 and/or have an installed app that could communicate via the communication facilitator ecosystem 100. The communications devices 155 will each also comprise one or more memory units, one or more processors, and a screen.

Prior to the patient being discharged, the nurse 135 or some other member of the patient's healthcare team ensures (1) that the patient 125 has follow up appointments scheduled with the patient's PCP or other specialist, (2) that a discharge summary has been completed with a copy sent to the patient's PCP and/or other specialist(s), and (3) that the patient's medications are delivered by the pharmacy or provided by the hospital. Additionally, the communication network is implemented before or soon after the patient is discharged from the hospital by having the nurse 135 or some other member of the patient's healthcare team enroll the patient onto the communication facilitator application ecosystem 100. Next, the patient may be educated on the use of the communication facilitator application ecosystem 100. During the education process, the patient may be guided to download the app onto the patient's smartphone and/or will be trained on the web interface of the communication facilitator application. A member of the patient's healthcare team, which may also be an administrator of the communication facilitator application, will ensure that the list of one or more members of the patient's healthcare team group is stored in a patient's electronic record. In addition, follow up appointments, discharge instructions, and a medication list may also be stored in the patient's electronic record at the same time or at a later time. The patient's electronic record may be co-located with server 105 of the communication facilitator ecosystem 100 and/or remotely located. If the patient's electronic record is co-located, then the electronic record may reside on the one or more memory units 110 of server 105. If the patient's electronic record is remotely located, then the electronic record may reside on some other memory units not on server 105. In some embodiments, the patient's electronic record may comprise access to a hospital's own electronic record that was created during the patient's time at the hospital. The hospital can determine how much of the hospital's electronic record is accessible via the patient's electronic record of the communication facilitator application ecosystem. By having the follow up appointments and a medication list for the patient stored in the patient's electronic record, the server 105 of the communication facilitator application ecosystem 100 is capable of sending the patient message reminders for any upcoming follow up appointments with the doctor, PCP, and/or specialist(s) as well as message reminders to take their medications. The patient 125 will be able to control whether or not to receive these reminders. The patient will be able to login to their account within the communication facilitator in order to add, delete, or modify their medication and appointment reminders. The patient will also have the option of adding additional phone numbers and email addresses that should also receive the medication and appointment reminders. This option would be helpful for having the patient's assistants and/or care takers to also be able to receive the medication and appointment reminders.

With this new communication facilitator application ecosystem, the traditional roadblocks to communication between the patient and members of their healthcare team have been mostly removed. After discharge, the patient is now able to communicate via the communication facilitator application ecosystem in the form of a message, such as a text message, a voice message, a picture message, a video message, and/or an email message, by sending questions or concerns they may have regarding their treatment to one or more members of the patient's healthcare team. Prior to a message being delivered, a check is done to see if the communication is permitted between the sender and recipient. In order to prevent a deluge of messages from the patient to the doctor, the patient at first may only be able to communicate with the case manager, nurse, and/or pharmacist. The doctor would still be able to monitor the communication between the patient and the case manager, nurse, and/or pharmacist and when appropriate, the doctor may contact the patient directly via the communication facilitator application ecosystem. Once the doctor has reached out directly to the patient, this communication chain is left open, i.e. the patient can contact the doctor directly, until the matter is marked resolved by the doctor or some other member of the patient's healthcare team. Once the matter is marked resolved, the patient may no longer communicate directly with the doctor. Within this communication facilitator application ecosystem, the doctor 130 would be able to clarify any doubts or concerns the patient may have relating to the patient's symptoms and/or care plan. The nurse 135 would be able to address any nursing issues such as wound care and doubts relating to the patient's care plan. The pharmacist 140 would be able to clarify any issues relating to the patient's medicines and would be able to check the patient's medicine list for possible interactions. The pharmacist 140 would also be able to make recommendations on poly-pharmacy and to possibly catch any prescribing errors. Additionally, the pharmacist would be able to counsel the patient on side effects and adverse reactions of the patient's medications. The case manager 145 would be able to address any issues relating to out-patient arrangement of home health services, durable medical equipment, and/or out-patient rehabilitation as well as be able to work with the patient's pharmacy to provide discounted medications in order to improve care plan compliance and outcomes. Other members of the patient's healthcare team 150 may be added to the communication facilitator application ecosystem for the patient where appropriate, such as medical specialist and hospitalists. With this new communication facilitator application ecosystem, patient satisfaction and health outcomes should be improved and patient re-admissions should be reduced.

The communication facilitator application ecosystem may also be deployed in other settings where improved communications between patient and healthcare professional is desirable. A few such facilities include but are not limited to Skilled Nursing Facilities, Rehabilitation Facilities, Long Term Acute Care Facilities, or Home Health Care Providers. The improved communications in such facilities would enhance the efficiency and quality of care that the healthcare professional is able to provide which should result in an overall improvement in health outcomes.

The health care industry is not the only environment where the communication facilitator application ecosystem can be deployed. The communication facilitator application ecosystem may bring benefits to any setting where coordinated and secure group communications are essential, such as commercial and government settings.

Some embodiments described herein relate to a computer storage product with one or more non-transitory memory units having instructions or computer code thereon for performing various computer-implemented operations. The one or more memory units are non-transitory in the sense that they do not include transitory propagating signals per se (e.g., a propagating electromagnetic wave carrying information on a transmission medium such as space or a cable). The one or more memory units and computer code (also can be referred to as code) may be those designed and constructed for the specific purpose or purposes. Examples of one or more memory units include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM), and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

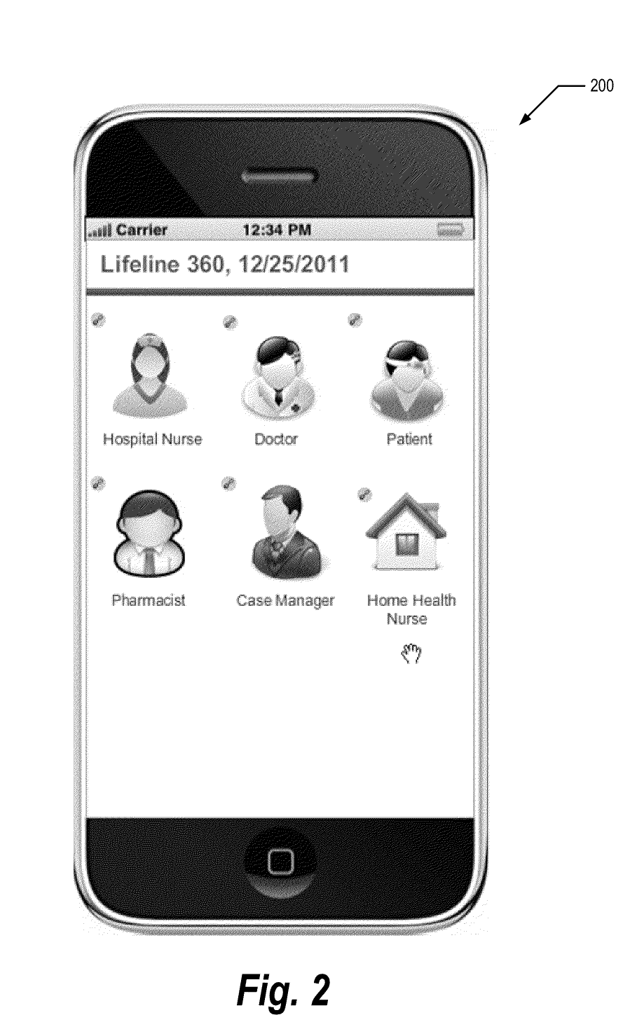

FIG. 2 is a smartphone screenshot of the initial screen of the communication facilitator application, in accordance with some embodiments.

In some embodiments, the initial screen of the app 200 when it is first accessed after being installed on a smartphone allows the user to select the kind of user that is trying to sign-on. In this embodiment, the screen shows the name of the app, Lifeline 360. Within the main body of the screen, various icons represent the different types of users that may be part of the communication facilitator application ecosystem such as a hospital nurse, a doctor, a patient, a pharmacist, a case manager, and a home health nurse. At this screen, the user may select their appropriate icon in order to access the subsequent sign-on screen. In other embodiments, the initial screen will include icons for other members of the patient's healthcare team. A similar user selection option will be presented to a user trying to access the communication facilitator application via a web browser. In other embodiments, this initial user type selection is not included and instead, a registered user would be immediately prompted to enter their user identification and password for authentication to the communication facilitator application ecosystem.

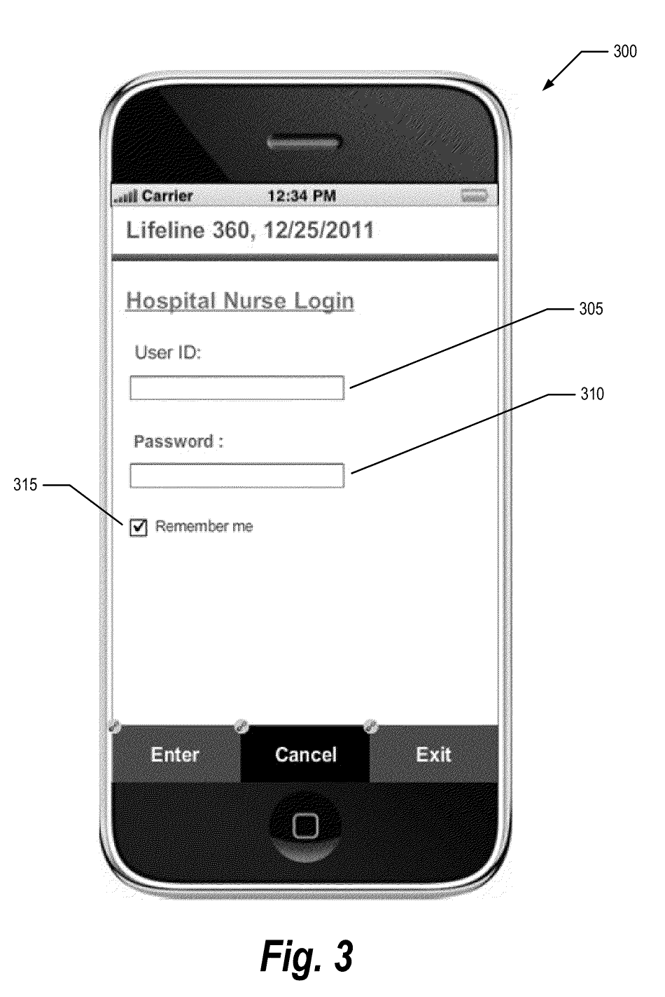

FIG. 3 is a smartphone screenshot of the login screen of the communication facilitator application, in accordance with some embodiments.

In some embodiments, the sign-on screen 300 will include the name of the type of user that is trying to sign-on. In the embodiment illustrated in FIG. 3, a hospital nurse is trying to login or sign-on. For the case of a hospital nurse, the user is prompted to enter their User ID, which may be a license number, phone number, and/or email address, in box 305 and their password in box 310. The user is also given the option to “Remember me” 315 so that they don't have to enter some or all the information in boxes 305 and 310 every time they login to the app. A similar login screen will be presented to a user trying to login into the communication facilitator application ecosystem via a web browser.

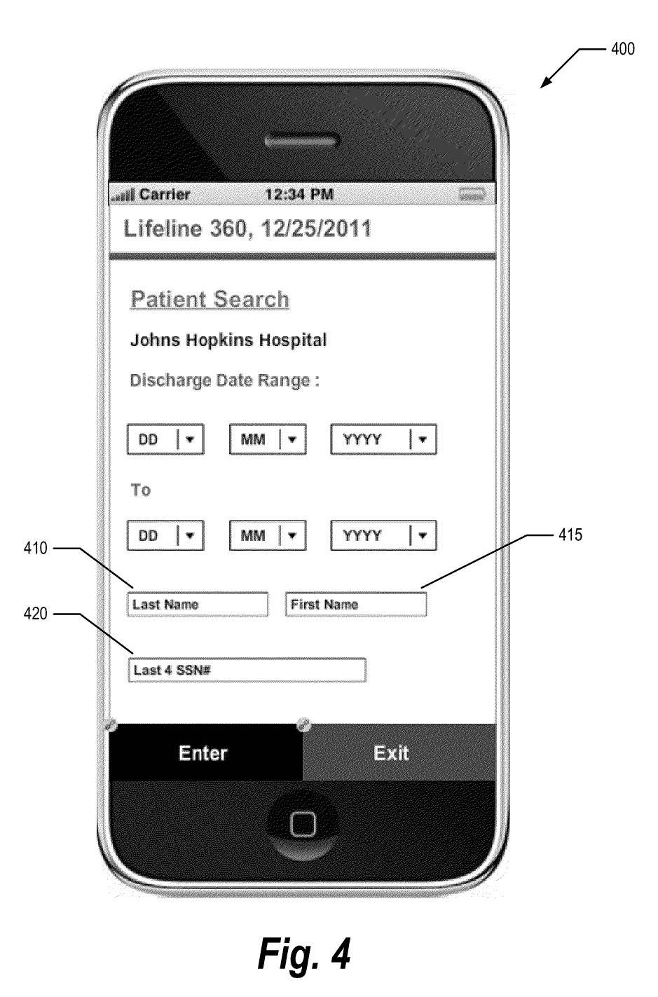

FIG. 4 is a smartphone screenshot of the patient search screen of the communication facilitator application, in accordance with some embodiments.

In some embodiments, any member of the patient's healthcare team will have the option to search for a particular patient that they are connected to within the communication facilitator application ecosystem. In the patient search screen 400, any member of the patient's healthcare team can search by hospital. In the embodiment illustrated in FIG. 4, the hospital to be searched is the Johns Hopkins Hospital. The member of the patient's healthcare team can also search by patient's last name 410, patient's first name 415, last four digits of patient's social security number 420, and by specific discharge date range. In other embodiments, it is also possible to search for patients with particular diagnoses as well. A similar patient search screen will be presented to a user of the communication facilitator application ecosystem via a web browser.

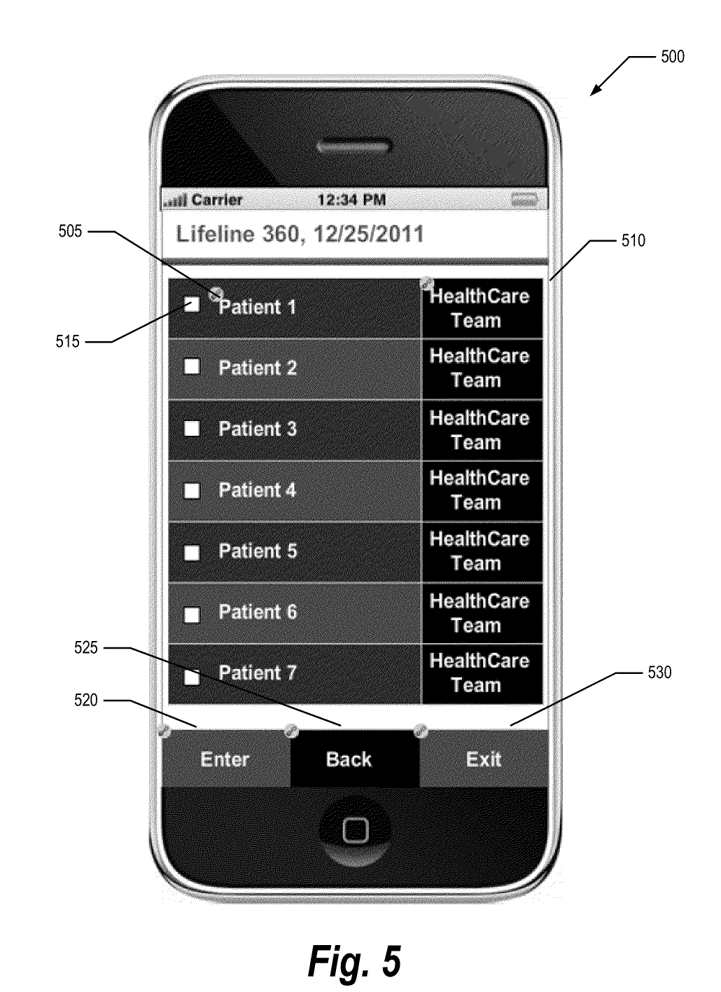

FIG. 5 is a smartphone screenshot of list of patients that the healthcare team member is a part of, in accordance with some embodiments.

In some embodiments, a patient list screen 500, either after searching for a particular patient or just listing of all the patients that the healthcare team member is a part of will be displayed along with a button for the patient's healthcare team 510. Due to space constraints, only a portion of the patient list is visible at one time, but the user has the option to scroll down to view the rest of the list of patients. From this screen, the user has the option to select one or more patients with whom to communicate with by first checking the box 515 adjacent to the patient name 505 and selecting Enter 520. The user also has the option of backing out, Back 525, of the patient list screen or exiting, Exit 530, from the application altogether. The healthcare team member can also see the list of the healthcare team for a particular patient by selecting the icon adjacent the right side of the patient name. In alternative embodiments, there is only a single “HealthCare Team” button, similar to the Enter 520 option, and therefore the list of the patient's healthcare team may be accessed by first selecting the patient box 515 and then selecting the single “Healthcare Team” button. A similar patient list screen will be presented to a user of the communication facilitator application ecosystem via a web browser.

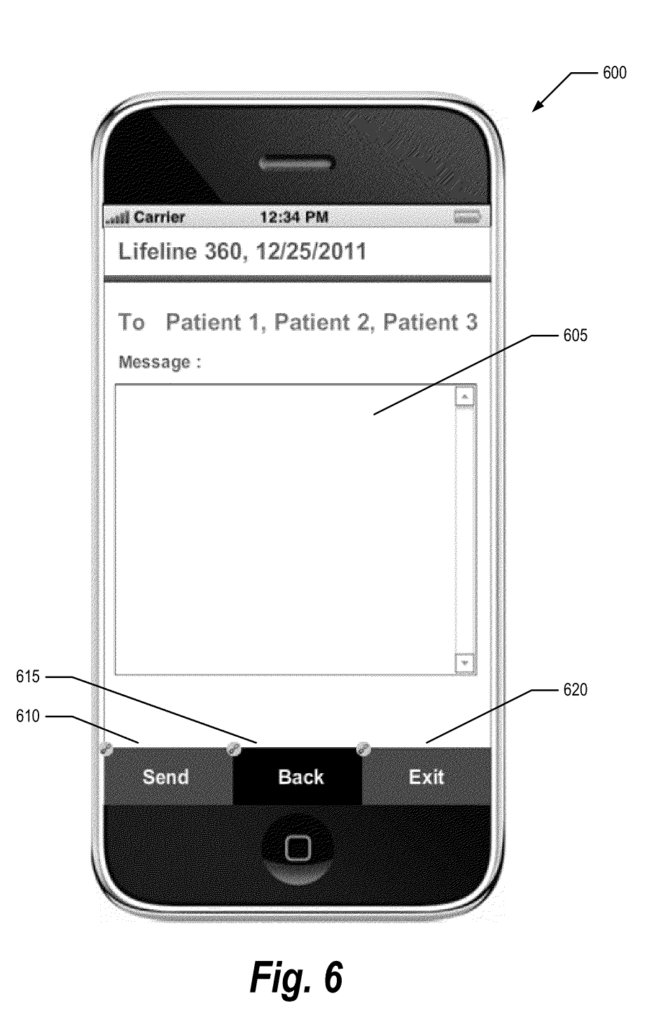

FIG. 6 is a smartphone screenshot of the text message input screen of the communication facilitator application, in accordance with some embodiments.

In some embodiments, a message input screen 600 will allow a member of the patient's healthcare team to send a message to one or more of their patients. In the embodiment illustrated in FIG. 6, Patient 1, Patient 2, and Patient 3 have been selected to receive the text message sent by the healthcare team member. After entering the message into text box window 605, the user can send the message by selecting the send button 610. The user also has the option of backing out, Back 615, of the text messaging input screen or exiting, Exit 620, from the application altogether. A similar text message input screen will be presented to a user of the communication facilitator application ecosystem via a web browser.

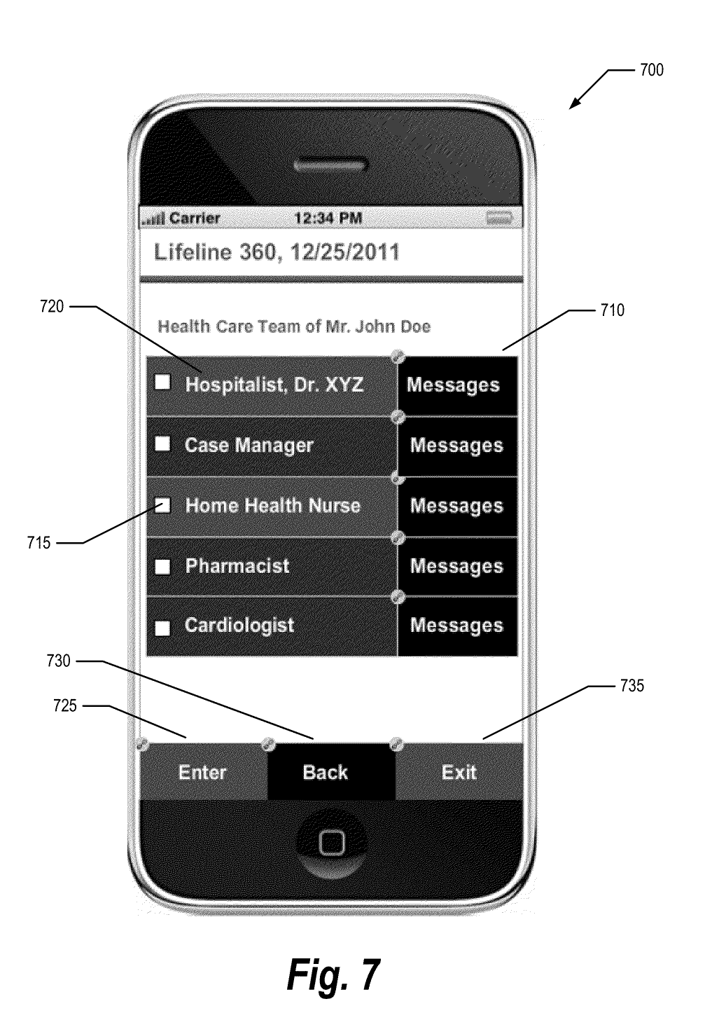

FIG. 7 is a smartphone screenshot of the healthcare team list for a particular patient, in accordance with some embodiments.

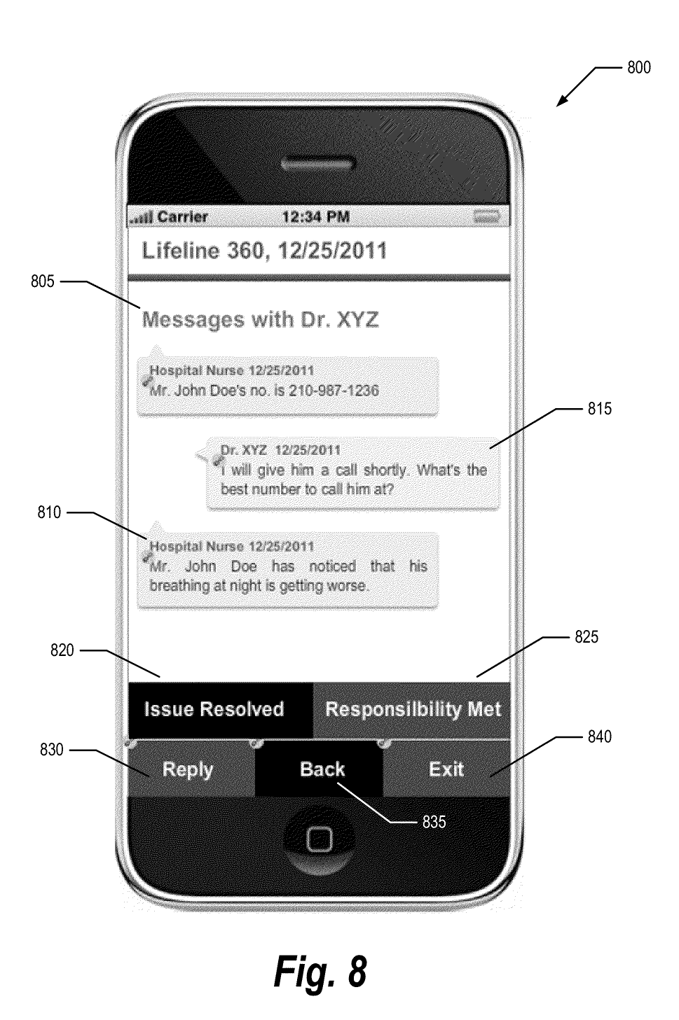

In some embodiments, a healthcare team list screen 700 will show the members of the healthcare team for a particular patient. In the embodiment shown in FIG. 7, the patient Mr. John Doe has five other members on their healthcare team, a hospitalist, a case manager, a home health nurse, a pharmacist, and a cardiologist. Adjacent to each of the team members is a button 710 that links to another screen that shows the messages between the hospital nurse (as this was the healthcare team member that was signed in back in FIG. 3) and the other healthcare team members. Example message exchanges are illustrated in FIGS. 8-12 between the hospital nurse and other members of the healthcare team. From the healthcare team list screen, the hospital nurse is capable of selecting one or more healthcare team members to which to send a message by first checking the box 715 adjacent to the healthcare team member 720 and then selecting Enter 725. A text message input screen similar to that of FIG. 6 will then be presented to the hospital nurse. The hospital nurse also has the option of backing out, Back 730, of the healthcare team list screen or exiting, Exit 735, from the application altogether. A similar healthcare team list will be presented to a user of the communication facilitator application ecosystem via a web browser.

FIG. 8 is a smartphone screenshot of a text message exchange between a hospital nurse and a doctor of the patient, in accordance with some embodiments.

In some embodiments, the patient's hospital nurse will be able to quickly and efficiently communicate with the patient's hospitalist within the messaging capability of the communication facilitator application ecosystem. The text messaging exchange screen 800 shows the exchange between the hospital nurse, who is signed onto the smartphone, and the hospitalist, Dr. XYZ. The text messaging exchange screen 800 may show a title 805 indicating with whom the messaging exchange is taking place with as well as a running history of messages sent by the hospital nurse 810 and messages received by Dr. XYZ 815. The hospital nurse is capable of marking the messaging exchange as Issue Resolved 820 and/or Responsibility Met 825. The hospital nurse also has the option of initiating a Reply 830, backing out, Back 835, of the text messaging exchange screen, or exiting, Exit 840, from the application altogether. In the text messaging exchange screen 800 the hospital nurse is letting Dr. XYZ know that the patient Mr. John Doe's breathing is getting worse at night. Dr. XYZ responds by asking for a contact number where they can reach the patient. The hospital nurse can quickly provide Dr. XYZ the phone number for the patient. From within the communication facilitator application ecosystem, Dr. XYZ will be able to initiate a phone call to the patient such that the caller ID that will be shown to the patient will be that of the communication facilitator application ecosystem, i.e. Lifeline 360, and not that of the doctor. In one embodiment, the call is initiated by the doctor entering or selecting the number to call, which results in the doctor's phone ringing first. After the doctor answers his phone, he will hear the ringing of the patient's phone. Having this feature helps to block the doctor's cell phone number from the patient and also has the benefit of increasing the chance that the patient will pick up a call identified as Lifeline 360 versus some other identifier or unrecognized number.

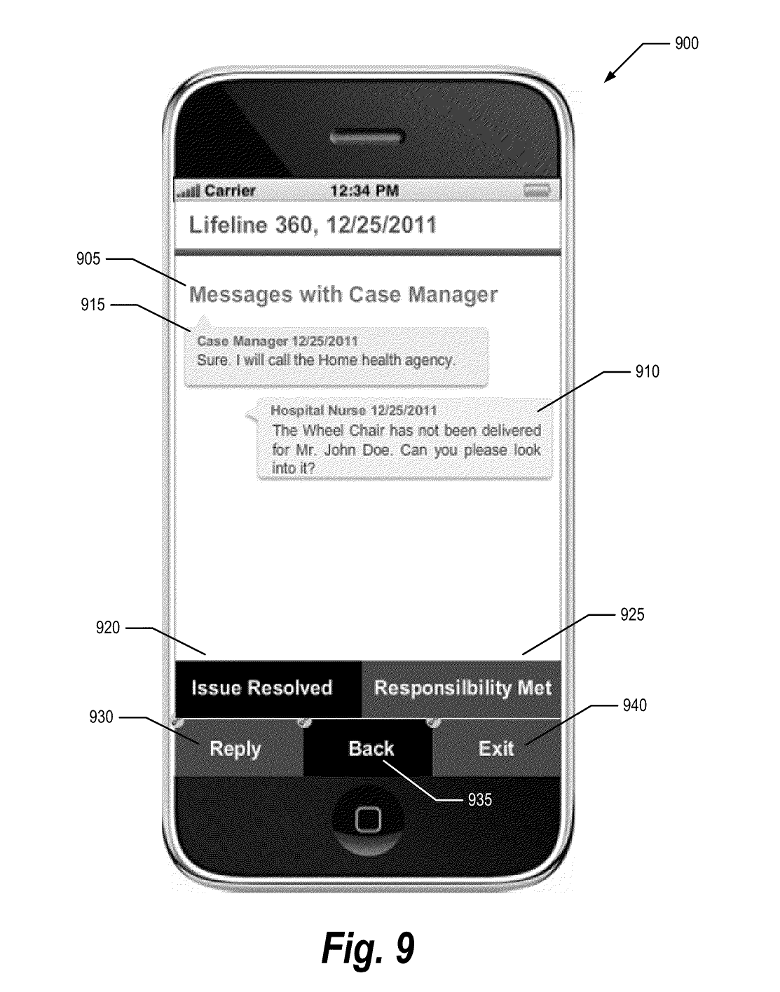

FIG. 9 is a smartphone screenshot of a text message exchange between a hospital nurse and a case manager of the patient, in accordance with some embodiments.

In some embodiments, the patient's case manager will be able to quickly and efficiently communicate with the patient's hospital nurse within the messaging capability of the communication facilitator application ecosystem. The text messaging exchange screen 900 shows the exchange between the hospital nurse, who is signed onto the smartphone, and the case manager. The text messaging exchange screen 900 may show a title 905 indicating with whom the messaging exchange is taking place with as well as a running history of messages sent by the hospital nurse 910 and messages received by the case manager 915. The hospital nurse is capable of marking the messaging exchange as Issue Resolved 920 and/or Responsibility Met 925. The hospital nurse also has the option of initiating a Reply 930, backing out, Back 935, of the text messaging exchange screen, or exiting, Exit 940, from the application altogether. In the text messaging exchange screen 900 the hospital nurse is letting the case manager know that the patient Mr. John Doe has not been delivered a wheel chair and to see if the case manager can look into it. The case manager responds by letting the hospital nurse know that they will contact the home health agency.

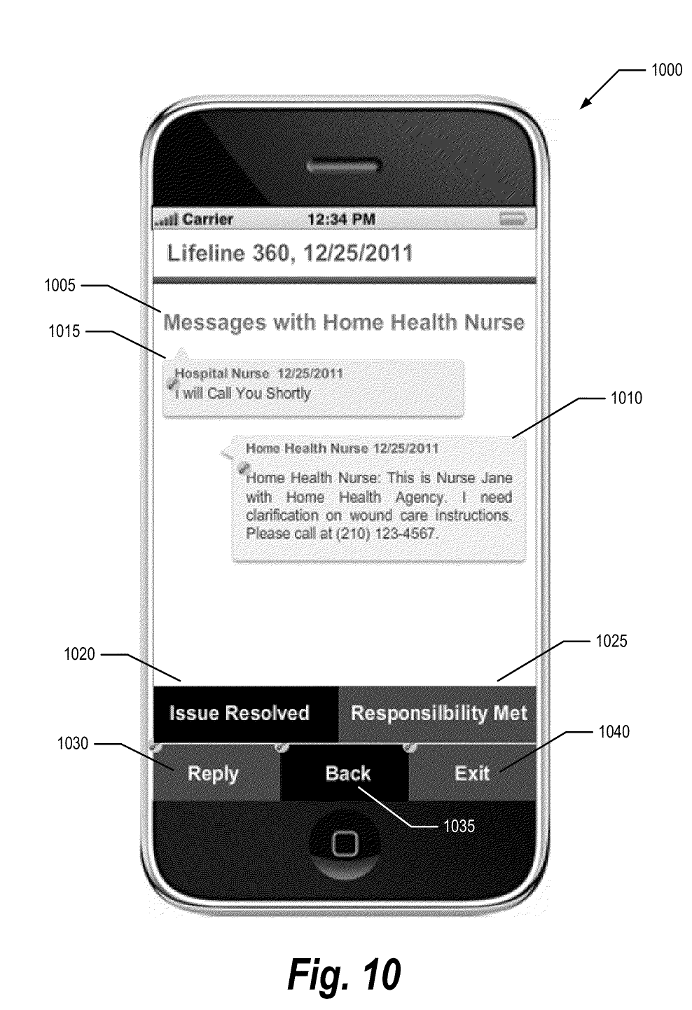

FIG. 10 is a smartphone screenshot of a text message exchange between a hospital nurse and a home health nurse of the patient, in accordance with some embodiments.

In some embodiments, the patient's home health nurse will be able to quickly and efficiently communicate with the patient's hospital nurse within the messaging capability of the communication facilitator application ecosystem. The text messaging exchange screen 1000 shows the exchange between the hospital nurse, who is signed onto the smartphone, and the home health nurse. The text messaging exchange screen 1000 may show a title 1005 indicating with whom the messaging exchange is taking place with as well as a running history of messages received by the home health nurse 1010 and messages sent by the hospital nurse 1015. The hospital nurse is capable of marking the messaging exchange as Issue Resolved 1020 and/or Responsibility Met 1025. The hospital nurse also has the option of initiating a Reply 1030, backing out, Back 1035, of the text messaging exchange screen, or exiting, Exit 1040, from the application altogether. In the text messaging exchange screen 1000 the home health nurse is asking for clarification on wound care instructions. The hospital nurse responds by letting the home health nurse know that they will call shortly.

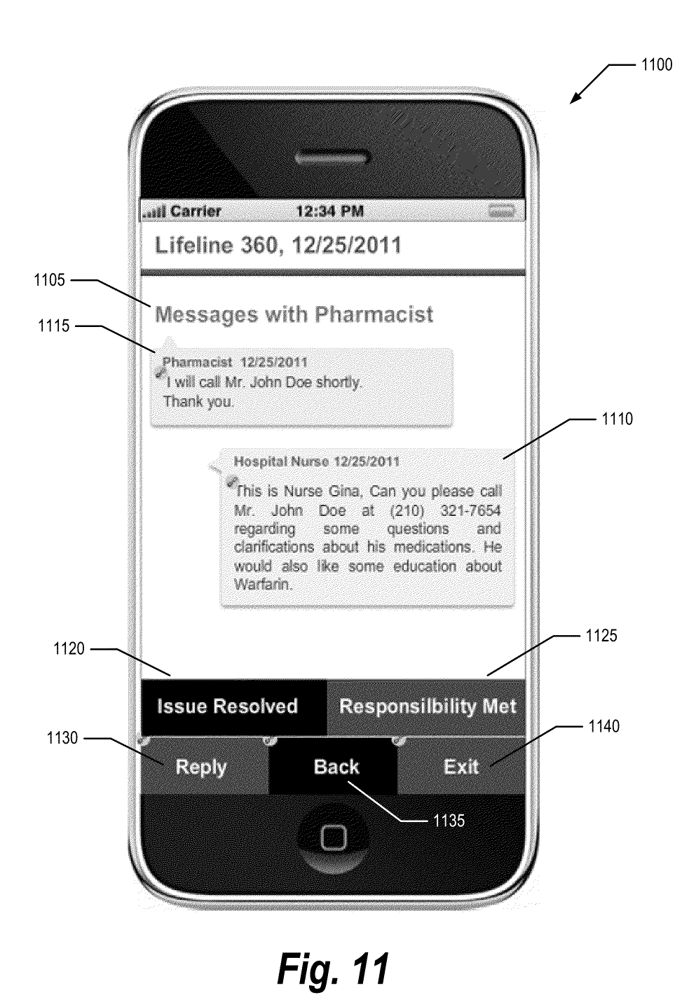

FIG. 11 is a smartphone screenshot of a text message exchange between a hospital nurse and a pharmacist of the patient, in accordance with some embodiments.

In some embodiments, the patient's hospital nurse will be able to quickly and efficiently communicate with the patient's pharmacist within the messaging capability of the communication facilitator application ecosystem. The text messaging exchange screen 1100 shows the exchange between the hospital nurse, who is signed onto the smartphone, and the pharmacist. The text messaging exchange screen 1100 may show a title 1105 indicating with whom the messaging exchange is taking place with as well as a running history of messages sent by the hospital nurse 1110 and messages received by the pharmacist 1115. The hospital nurse is capable of marking the messaging exchange as Issue Resolved 1120 and/or Responsibility Met 1125. The hospital nurse also has the option of initiating a Reply 1130, backing out, Back 1135, of the text messaging exchange screen, or exiting, Exit 1140, from the application altogether. In the text messaging exchange screen 1100 the hospital nurse is asking that the pharmacist contact the patient Mr. John Doe for clarification on their medications. The pharmacist responds by letting the hospital nurse know that they will call the patient shortly.

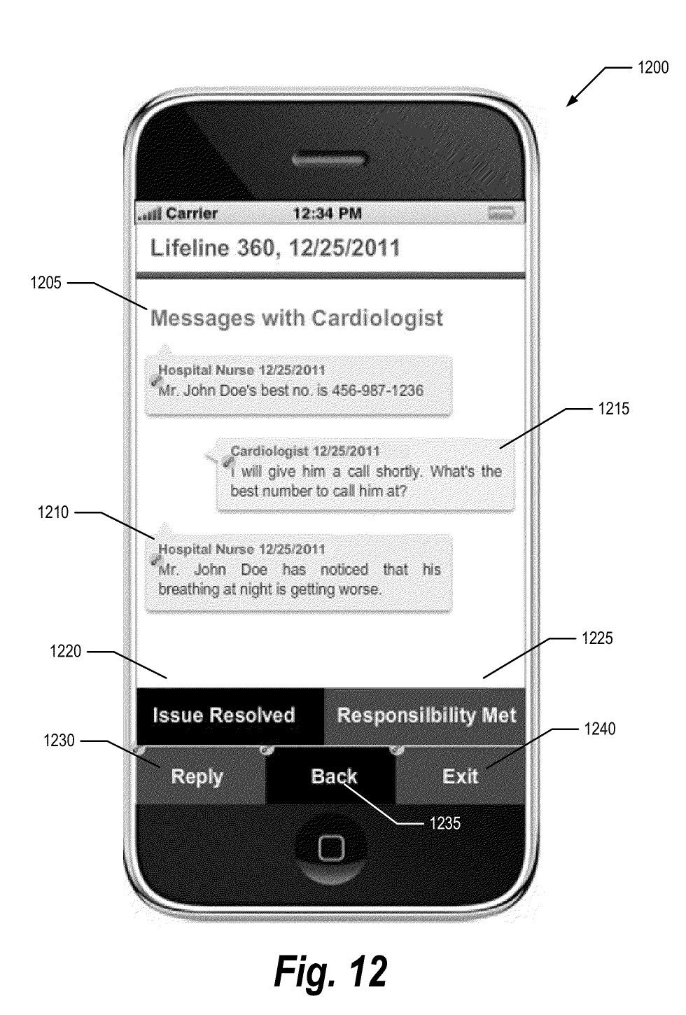

FIG. 12 is a smartphone screenshot of a text message exchange between a hospital nurse and a cardiologist of the patient, in accordance with some embodiments.

In some embodiments, the patient's cardiologist will be able to quickly and efficiently communicate with the patient's hospital nurse within the messaging capability of the communication facilitator application ecosystem. The text messaging exchange screen 1200 shows the exchange between the hospital nurse, who is signed onto the smartphone, and the cardiologist. The text messaging exchange screen 1200 may show a title 1205 indicating with whom the messaging exchange is taking place with as well as a running history of messages sent by the hospital nurse 1210 and messages received by the cardiologist 1215. The hospital nurse is capable of marking the messaging exchange as Issue Resolved 1220 and/or Responsibility Met 1225. The hospital nurse also has the option of initiating a Reply 1230, backing out, Back 1235, of the text messaging exchange screen, or exiting, Exit 1240, from the application altogether. In the text messaging exchange screen 1200 the hospital nurse is letting the cardiologist know that the patient Mr. John Doe's breathing is getting worse at night. The cardiologist responds by asking for a contact number where they can reach the patient. The hospital nurse can quickly provide the cardiologist the phone number for the patient.

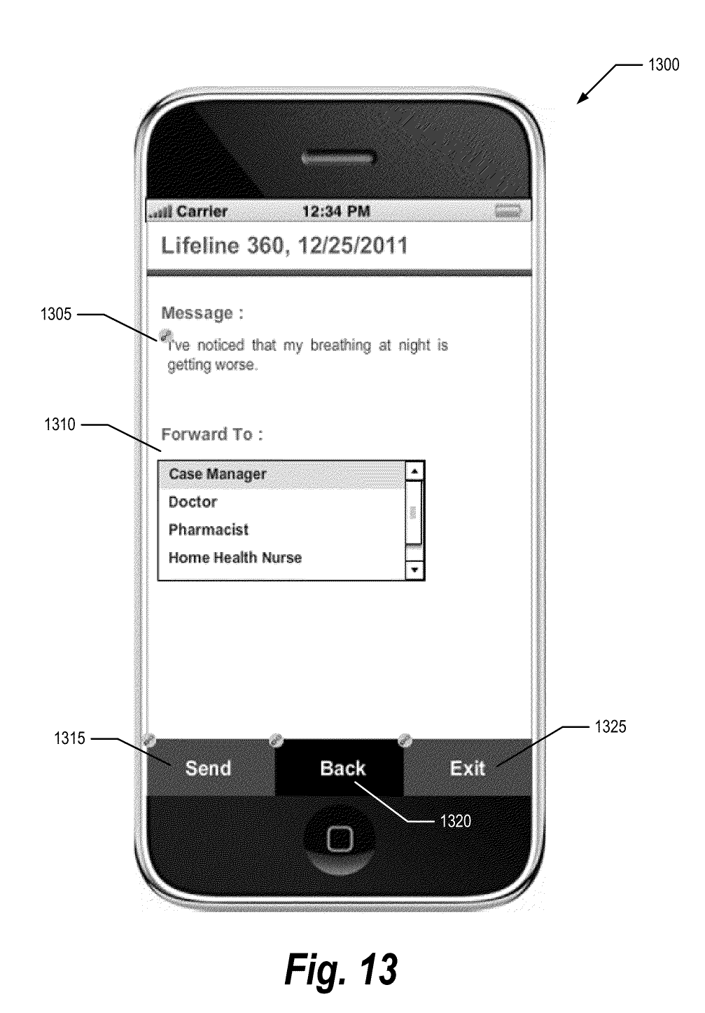

FIG. 13 is a smartphone screenshot illustrating the option of forwarding a patient's message to one or more healthcare team members, in accordance with some embodiments.

In some embodiments, a patient's message received by a healthcare team member may be forwarded to one or more healthcare team members. The message forwarding screen 1300 shows the patient's message 1305 received by the hospital nurse, who is signed onto the smartphone, and a list 1310 of other healthcare team members that the message may be forwarded to. After selecting the healthcare team members to whom the patient's message should be forwarded to, the hospital nurse can send the message by selecting the send button 1315. The hospital nurse also has the option of backing out, Back 1320, of the message forwarding screen or exiting, Exit 1325, from the application altogether. A similar message forwarding screen will be presented to a user of the communication facilitator application ecosystem via a web browser.

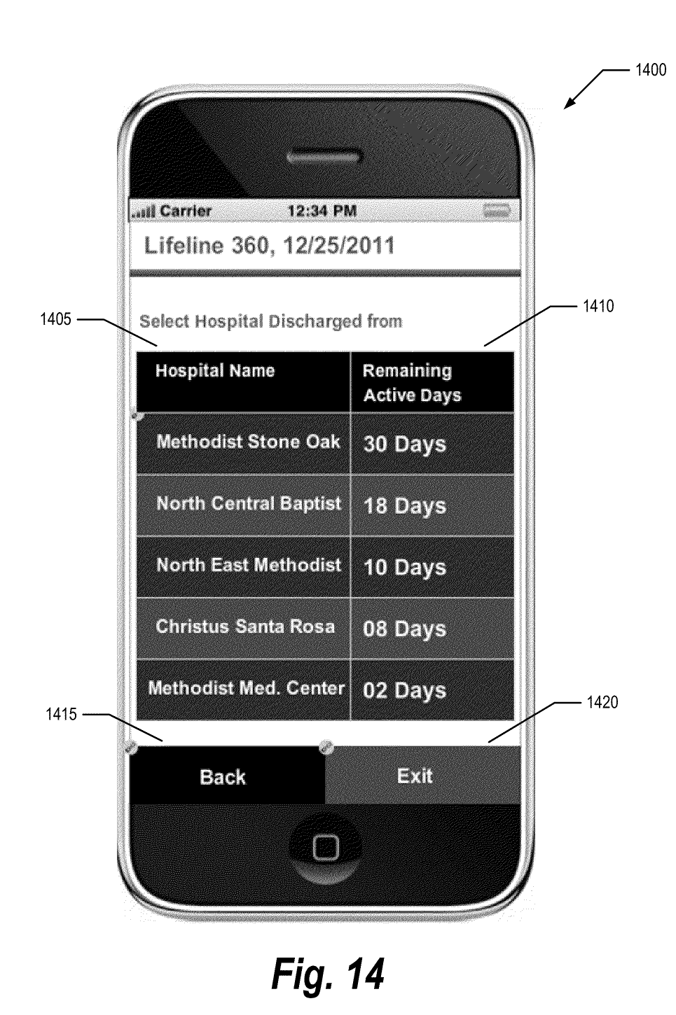

FIG. 14 is a smartphone screenshot of a patient's hospital admission history, in accordance with some embodiments.

In some embodiments, a member of the patient's healthcare team may be able to check on the patient's hospital admission history. The hospital admission history screen 1400 shows the hospitals/healthcare facilities that the patient has been discharged from within the last ninety days 1405 and the number of days of ‘access’ remaining 1410. Access means the ability for the patient to communicate with their healthcare team via the communication facilitator application ecosystem. The healthcare entity can determine how many days of ‘access’ they can give their patients after discharge and will be displayed as ‘remaining active days’ next to the facility name. By clicking on a particular hospital, the patient's healthcare team member can view the details of the patient's enrollment in that particular hospital as well as the details of the healthcare team for that particular hospitalization. The patient's healthcare team member has the option of backing out, Back 1415, of the hospital admission history screen or exiting, Exit 1420, from the application altogether. A similar hospital admission history screen will be presented to a user of the communication facilitator application ecosystem via a web browser.

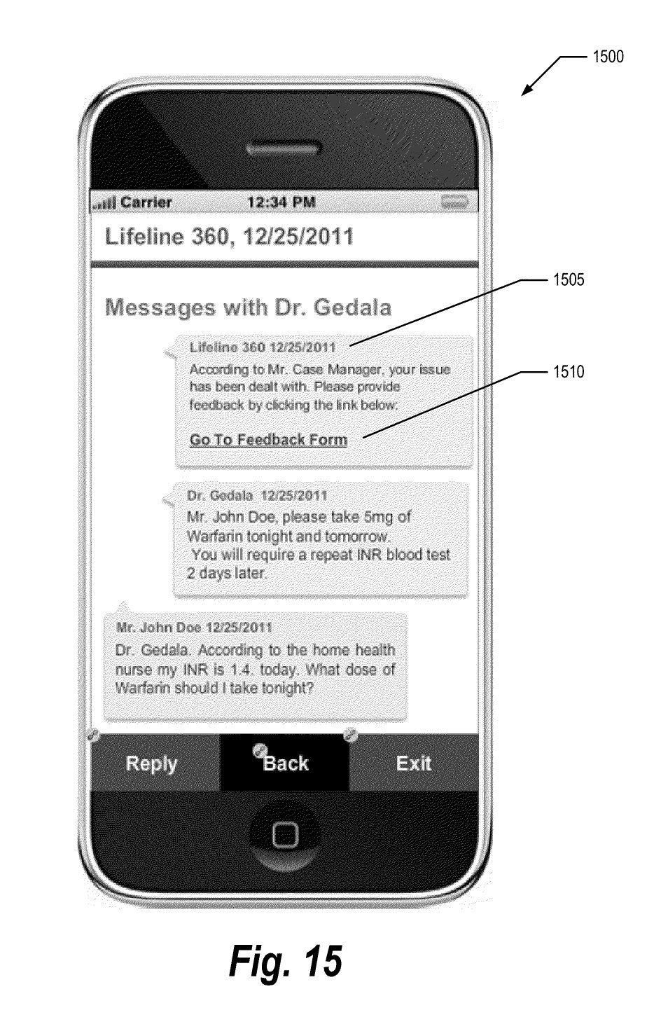

FIG. 15 is a smartphone screenshot of a text messaging exchange between a patient and their doctor allowing the patient to link to a feedback form, in accordance with some embodiments.

In some embodiments, as shown in the text messaging screenshot 1500, an administrator of the communication facilitator application ecosystem 1505 may present the patient with a link to a Feedback Form 1510 where the patient can leave feedback regarding the issue that the patient originally contacted the doctor. In the text messaging screenshot 1500, the patient Mr. John Doe contacted Dr. Gedala to ask what dose of Warfarin should be taken if their INR is 1.4. Dr. Gedala responded to Mr. John Doe with the required dosage as well as an instruction to repeat the INR blood test two days later.

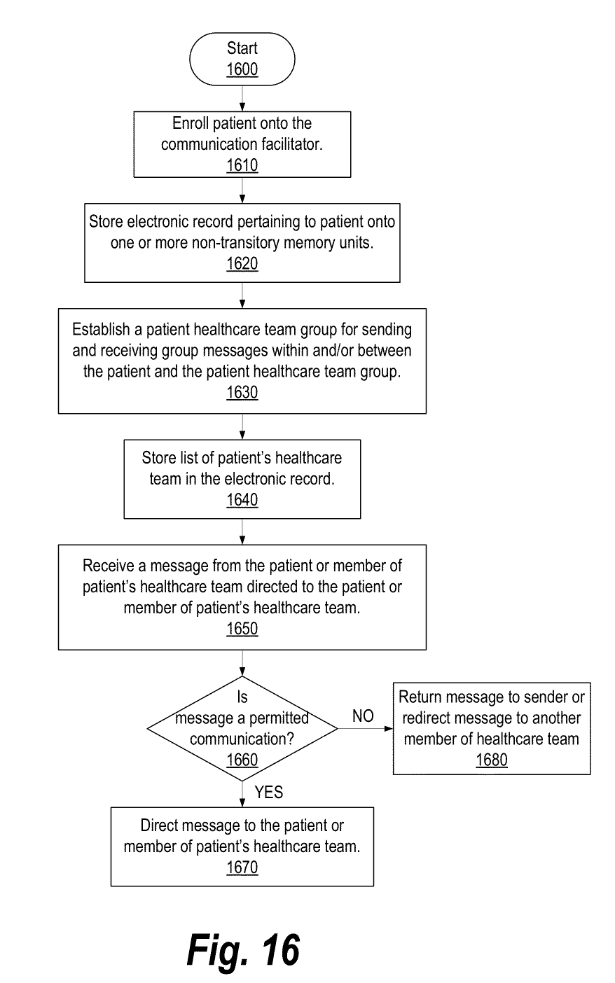

FIG. 16 is a block diagram illustrating a method for coordinating post-discharge care of hospitalized patients, in accordance with some embodiments.

Processing begins at 1600 whereupon, at block 1610, a patient is enrolled onto the communication facilitator. In some embodiments, the method illustrated in FIG. 16 may be performed by one or more of the devices illustrated in FIGS. 1 to 15. At block 1620, an electronic record pertaining to the patient is stored on the one or more non-transitory memory units. The patient's record is stored onto the one or more non-transitory memory units in order to be able to quickly add, access, and retrieve information pertaining to the patient. At block 1630, a healthcare team group of the patient is established for sending and receiving group messages within and/or between the patient and the patient healthcare team group. The healthcare team group can be any number of doctors, nurses, pharmacists, and case managers that are going to monitor the patient's progress after being discharged from the hospital. At block 1640, the list of the members of the patient's healthcare team group is stored in the electronic record. At block 1650, the message sent by the patient or the one or more members of the patient healthcare team group and directed to the patient or the one or more members of the patient healthcare team group is received. At block 1660, a check is made to see if the message between the sender and recipient is a permitted communication. If the message is a permitted communication, the processing continues to block 1670 where the message is directed to the patient or member of patient's healthcare team. If the message is not a permitted communication, the processing continues to block 1680 where the message is returned to the sender as undeliverable. In alternative embodiments, the message may be redirected to another member of the patient's healthcare team that is permitted to receive the message. In yet other alternative embodiments, an in-built scheduling system may be integrated into the Communication Facilitator Code such that the doctor's schedule can be updated allowing rerouting of messages originally sent to a doctor that is off or not on-call to another doctor who is covering.

In some other embodiments, the application can also store the ‘location’ of each user's smartphone if the user permits it. A member of the patient's healthcare team, which may also be an administrator of the communication facilitator application, may then be able to see a display of all users in a certain geographic area. With this data, trend analysis can be done to look for various patterns such as the decrease in density of a hospital's customer base in a particular geographic area over a time period (e.g. one year) may suggest that those patients likely may be using the services of a competitor instead. Another example of how geographic trend analysis may be used is to look for ‘spots with low density’ within the catchment area of the hospital as a potential site to establish a new ER or urgent care center to tap into that population for a customer base.

In some other embodiments, the communication facilitator application system also has language translation capabilities for those who cannot communicate in English. Thus, if for example, the patient sends a message in Spanish, but the healthcare team member's preferred language is English, the healthcare team member will receive the English translation. A copy of the message both in English and Spanish will be saved on the communication facilitator application system server.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. An apparatus for coordinating care of patients, the apparatus comprising:
one or more processors;
system memory coupled to the one or more processors;
one or more non-transitory memory units coupled to the one or more processors; and
communication facilitator code stored on the one or more non-transitory memory units that when executed by the one or more processors are configured to perform a method, comprising:
enrolling a patient onto a communication facilitator;
storing an electronic record pertaining to the patient on the one or more non-transitory memory units;
establishing a patient healthcare team group for sending and receiving group messages within and/or between the patient and the patient healthcare team group, the patient healthcare team group being associated with the patient;
storing a list of one or more members of the patient healthcare team group in the electronic record;
receiving from the patient or the one or more members of the patient healthcare team group a message directed to the patient or the one or more members of the patient healthcare team group;
checking if the message is a permitted communication between the patient or the one or more members of the patient healthcare team group and the patient or the one or more members of the patient healthcare team group; and
if the message is a permitted communication, directing the message to the patient or the one or more members of the patient healthcare team group.

2. The apparatus of claim 1, wherein the method further comprises storing dates and times of one or more follow up appointments of the patient in the electronic record.

3. The apparatus of claim 2, wherein the method further comprises sending an appointment reminder message for the dates and times of the one or more follow up appointments.

4. The apparatus of claim 1, wherein the method further comprises storing a medication list of the patient in the electronic record.

5. The apparatus of claim 4, wherein the method further comprises sending a medication reminder message, wherein the medication reminder message includes the name and amount of medication and time that the patient should take the medication.

6. The apparatus of claim 1, wherein the method further comprises storing discharge instructions of the patient in the electronic record.

7. The apparatus of claim 6, wherein the method further comprises sending the discharge instructions to a PCP of the patient.

8. The apparatus of claim 1, wherein the patient healthcare team group comprises at least one of: a doctor, a nurse, a pharmacist, and a case manager.

9. The apparatus of claim 1, wherein the message comprises at least one of: a text message, a voice message, a picture message, a video message, and an email message.

10. The apparatus of claim 1, wherein the method further comprises placing a phone call to the patient such that the patient is presented with caller identification of the communication facilitator instead of caller identification of the one or more members of the patient healthcare team group.

11. A method for coordinating care of patients, the method comprising:
a computer system, which includes one or more processors, system memory coupled to the one or more processors, one or more non-transitory memory units coupled to the one or more processors, and communication facilitator code stored on the one or more non-transitory memory units;
enrolling a patient onto a communication facilitator;
storing an electronic record pertaining to the patient on the one or more non-transitory memory units;
establishing a patient healthcare team group for sending and receiving group messages within and/or between the patient and the patient healthcare team group, the patient healthcare team group being associated with the patient;
storing a list of one or more members of the patient healthcare team group in the electronic record;
receiving from the patient or the one or more members of the patient healthcare team group a message directed to the patient or the one or more members of the patient healthcare team group;
checking if the message is a permitted communication between the patient or the one or more members of the patient healthcare team group and the patient or the one or more members of the patient healthcare team group; and
if the message is a permitted communication, directing the message to the patient or the one or more members of the patient healthcare team group.

12. The method of claim 11, the method further comprising storing dates and times of one or more follow up appointments of the patient in the electronic record.

13. The method of claim 12, the method further comprising sending an appointment reminder message for the dates and times of the one or more follow up appointments.

14. The method of claim 11, the method further comprising storing a medication list of the patient in the electronic record.

15. The method of claim 14, the method further comprising sending a medication reminder message, wherein the medication reminder message includes the amount of medication and time that the patient should take the medication.

16. The method of claim 11, the method further comprising storing discharge instructions of the patient in the electronic record.

17. The method of claim 16, the method further comprising sending the discharge instructions to a PCP of the patient.

18. The method of claim 11, wherein the patient healthcare team group comprises at least one of: a doctor, a nurse, a pharmacist, and a case manager.

19. The method of claim 11, wherein the message comprises at least one of: a text message, a voice message, a picture message, a video message, and an email message.

20. The method of claim 11, the method further comprising placing a phone call to the patient such that the patient is presented with caller identification of the communication facilitator instead of caller identification of the one or more members of the patient healthcare team group.
